(19) United States
(12) Patent Application Publication
(10) Pub. No.: US 2009/0262383 A1
(43) Pub. Date: Oct. 22, 2009

(54) METHODS AND SYSTEMS FOR IMPROVED MULTI-PROCESSING UTILIZATION IN A PRINTING CONTROLLER

(76) Inventors: Gary Lin Gaebel, Vancouver, WA (US); Craig Thompson Whittle, Vancouver, WA (US)

Correspondence Address: Duft Bornsen & Fishman, LLP, 1526 Spruce Street, Suite 302, Boulder, CO, 80302, US

(21) Appl. No.: 12/103,832

(22) Filed: Apr. 16, 2008

(51) Int. Cl. G06F 15/00

(52) U.S. Cl. 358/1.15

(57) ABSTRACT

Methods and systems for enhanced parallel processing of data objects in a print job sent to a printing device having multiple processors. The entire print job (or any portion thereof) is spooled by an enhanced driver module on an attached host system and the data objects are re-ordered to allow for improved opportunity for parallel processing of the data objects on the multiple processors of the printing device. Capacity or capability information may be stored in a profile describing desired ordering of data objects to enable opportunity for parallel processing of the re-ordered data objects in the print job. The profile information may be statically configured for the printing device or may be dynamically determined through communication with the printing device.

### BACKGROUND

1. Field of the Invention

The invention relates generally to processing of print jobs in systems including a printing device having multiple processors for processing of received print jobs. More specifically, the invention relates to methods and systems for improved utilization of processors in a printing device by re-ordering of objects in a print job at the printer driver layer of processing.

2. Discussion of Related Art

Present day printing devices such as an inkjet or laser printers or multi-function devices typically include a printer/device controller integrated within the printing device and may incorporate multiple processors on the controller for purposes of processing data objects of a received print job. For example, such multiple processors may include a plurality of general-purpose processors such that processing tasks may be distributed over a plurality of essentially identical processors or may include a variety of types of processors, some general purpose and others specialized in their purpose such that particular data objects may be processed in particular processors best suited for the particular type of data object. For example, some print device controllers may include special purpose processors particularly efficient at processing image data, or color data, or vector data, etc.

Any number of such general-purpose processors and/or special purpose processors may be integrated within such a multi-processor printer controller. At present, most such systems using such multi-processor controllers assume responsibility within the printer controller for determining how best, if at all, to distribute processing of the objects of a received print job. In other words, the printer controller of the printing system makes its own determination as to how to best distribute the data objects of a received print job among the multiple processors. For example, if a particular print controller has a general purpose processor for processing any type of data object and an additional special-purpose processor dedicated to processing image data, received image data objects may be forwarded to the special purpose image data processor while other data objects may be directed to the general-purpose processor area.

When data objects are advantageously distributed among the plurality of processors, the printer controller may improve its performance by processing multiple data objects of a received print job substantially in parallel. In other words, each processor may be operable in parallel to process independent data objects of a received print job. However, to assure optimal performance in such a system, it may be required that the printer controller receive large amounts of data including multiple data objects in order to best determine how the data objects may be most effectively distributed among the plurality of processors. Such analytical processing requiring the storage of potentially large volumes of print job data objects may impose a severe resource requirement on the printer controller. For example, to fully optimize the potential for parallel processing by multiple processors of the print controller, it may be required that the print controller receive the entirety of a print job, perform its analysis for distribution of the data objects, and only then distribute the various objects among the plurality of processors. However receipt of such a large volume of data may require significant resources on the printer controller—resources far beyond those available on lower cost printer systems.

It is evident from the above discussion that a need exists for improved methods and systems for distribution of processing among a plurality of processors in a printer controller of a printing system.

### SUMMARY OF THE INVENTION

The present invention solves the above and other problems, thereby advancing the state of the useful arts, by providing methods and systems for determining the multi-processing capability of a printer within an attached host system. Thus features and aspects hereof utilize computational resources of the host system to re-order objects in a print job to allow for improved utilization of multiple processors within the printing system.

An aspect hereof provides a method for forwarding a print job to a printer. The method includes determining multi-processing capability within the printer and receiving a print job to be forwarded to the printer. The method then re-orders objects in the print job to generate a re-ordered print job in accordance with the multi-processing capability of the printer. The re-ordered print job is then forwarded to the printer for output of the print job on the printer using the multi-processing capability of the printer to process multiple objects in parallel on the printer.

Another aspect provides a method operable in a host system coupled to a multifunction device. The method re-orders objects in a print job, and includes determining, within the host system, a capacity of a first processor of the multifunction device to process image objects and a capacity of a second processor of the multifunction device to process other data objects. The capacities are determined from profile information regarding the multifunction device. The method then identifies image data objects in a received print job that may be processed in parallel with other data objects in the received print job. The method in the host system then re-orders objects in the print job to generate a re-ordered print job having image data objects grouped together and other data objects grouped together in accordance with the capacity of the first and second processors. The re-ordered print job is then transmitted from the host system to the multifunction device. The multi-function device then processes image objects of the re-ordered print job using the first processor of the multifunction device while processing other objects in parallel using the second processor of the multifunction device wherein the processing outputs the re-ordered print job on the multifunction device.

Still another aspect hereof provides a method operable in a host system adapted for coupling to a printer. The method includes determining a number of multiple processors in the printer and receiving a print job to be sent to the printer, the print job comprising a sequence of objects. The method then identifies objects in the received print job and associates each identified object with a corresponding processor of the multiple processors of the printer. The method then re-orders objects in the print job to generate a re-ordered print job having objects grouped together that are associated with a common corresponding processor. The re-ordered print job is then transmitted to the printer to generate printed output where objects are processed in parallel on the multiple processors of the printer.

### BRIEF DESCRIPTION OF THE DRAWINGS

FIG. 1 is a block diagram of an exemplary system incorporating features and aspects hereof to improve utilization of multiple processors in a printing device.

FIG. 2 is a flowchart describing an exemplary method in accordance with features and aspects hereof for improving utilization of multiple processors in a printing device.

FIGS. 3 and 4 are flowcharts providing exemplary additional details of processing in aspects of the method of FIG. 2.

FIG. 5 is a flowchart providing another exemplary method in accordance with features and aspects hereof to improve utilization of multiple processors in the printing device.

### DETAILED DESCRIPTION OF THE DRAWINGS

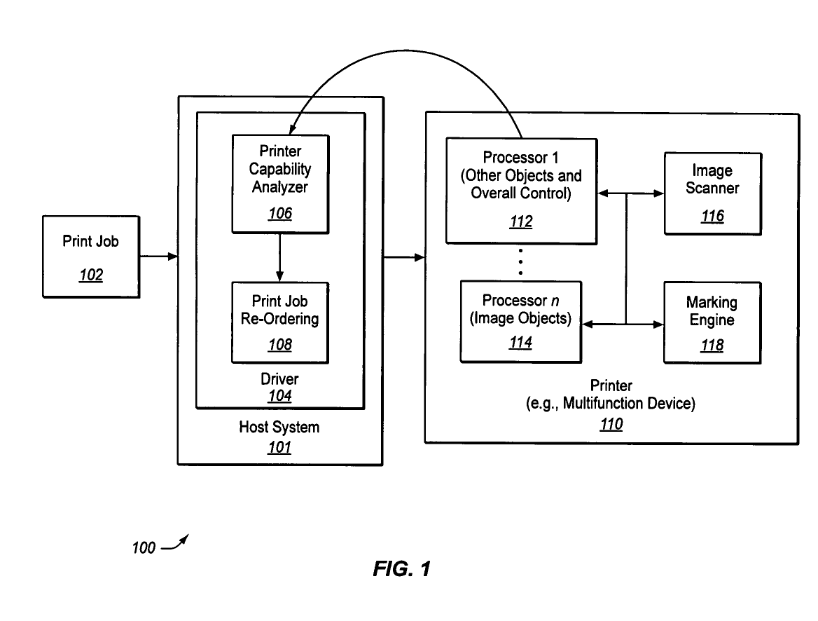

FIG. 1 is a block diagram showing an exemplary system 100 including a driver 104 operable within a host system 101 for processing a received print job 102 to improve utilization of multiple processors (112 and 114) within an attached printing device 110. Printing device 110 may be any suitable printing device including, for example, ink jet and laser printing devices embodied as standalone printers or as multi-function devices (including scanning and/or copying capabilities).

Driver 104 is typically integrated with operating system software operable in a host system 101. Host system 101 may be any suitable personal computer or workstation including, for example, a print server compute node coupled to other systems and printing device 110 through suitable networks. Regardless of the source of print job 102, driver 104 of host system 101 receives the print job and re-orders the data objects received within print job 102 by processing of print job re-ordering element 108. Typically, enhanced driver 104 also provides requisite translation of the received objects into corresponding objects for a particular page description language (PDL) supported by printing device 110. Thus, the re-ordering may be integrated with the processing by driver 104 to translate or transform the received objects into corresponding PDL objects. The particular re-ordering of objects within print job 102 by processing of element 108 of driver 104 improves potential for parallel processing of the re-ordered data objects by multiple processors within printing device 110.

Printing device 110 includes multiple processors 112 and 114 for processing data objects of a received print job (e.g., the re-ordered print job generated by processing of print job re-ordering element 108 of driver 104 in host system 101). Each of the multiple processors 112 and 114 of printing system device 110 may be either a general purpose processor or a special purpose processor as appropriate for the particular printing device application. Though FIG. 1 shows two processors (112 and 114), any number of processors (two or more) may be present in a particular printing system 110. At least one of the multiple processors (112) is also responsible for overall control of the printing device 110 including, for example, interaction with other peripheral components such as image scanner 116 and control of marking engine 118.

In many printing systems, at least one additional processor 114 is specialized in its processing to perform particular data processing computations appropriate for the specific types of data objects. For example, the second processor 114 of printing device 110 may be specially adapted for processing of image data objects. Thus, image data objects may be processed by processor 114 substantially in parallel with processing of other data objects by processor 112 within printing device 110. As noted above, any number of processors may be used in printing device 110. Further, the particular type or types of objects processed by each processor may be grouped and associated with each processor as appropriate for a particular application. Processing of image data objects by processor 112 and other objects by processor 114 is therefore intended merely as exemplary of one possible division of processing between various processors.

At least one processor 112 of the multiple processors of printing device 110 may interact with a printer capability analyzer element 106 of driver 104 within host system 101. This interaction may include return of information indicative of the multi-processor capability of printing device 110. Such information may be obtained once at initialization of the printing device 110 by driver 104 and thus may be static throughout operation of system 100. Alternatively, printer capability analyzer 106 of driver 104 may interact with printing device 110 from time to time to determine its current multi-processing capability. Thus, as the capacity of any processor to process data objects changes, printer capability analyzer 106 may obtain current performance information from printing device 110. Further, in the alternative, printing device 110 may asynchronously generate information indicating changes to the current multi-processing capacity of the printing device 110 and generate an appropriate message indicating such a change for processing within printer capability analyzer element 106. Still further, in other embodiments, printing device 110 may provide no capability for such bi-directional communication to inform driver 104 of current multi-processing capacity of the printing device 110. Thus capability analyzer element 106 may attempt to determine the multi-processing capability of printing device 110 from static configuration information (not shown) associated with the particular printing device 110. Whether dynamically obtained from the printing system or statically configured, the multi-processing capability of the device 110 may be determined from performance information including, for example: CPU utilization for each processor, size of the objects that may be processed by the CPUs, memory utilization in the printing device, disk space utilization in the printing device, current state of processing of the printing device, etc.

Regardless of how such multi-processing capability information is determined or obtained, the information may generally include capacity of each of the multiple processors for processing associated types of data objects. For example, the multi-processing capability/capacity information for a printing system having two processors (one for image data objects and another for all other objects) may include a first number (N) of image data objects that should precede (or follow) a second number (M) of non-image or other data objects (where N and M could be any integers greater than or equal to 1). Thus M and N may specify a particular sequence for reordering including interleaving consecutive objects of different object types. Responsive to such multi-processing capability information, re-ordering element 108 of enhanced driver 104 may thus re-order the data objects in the re-ordered print job it generates so that N (or less) image data objects will always precede (or follow) M (or less) non-image or other data objects in the re-ordered print job data. Still further exemplary capacity information may include information relating to the complexity of image data objects such as the total volume of image data to be processed derived from image color depth, image dimensions, image resolution, etc.

More analysis may be performed to identify appropriate and inappropriate groupings of objects where, for example, some common state information may be required to process multiple objects, or, for example, where the order of processing of data objects could affect the generated page image. The enhanced driver 104 will access sufficient information regarding the data objects of the print job to permit decisions relating to the propriety of such groupings. Such design choices in the analysis to determine appropriate re-ordering will be readily apparent to those of ordinary skill in the art.

Exchanges between the enhanced driver module 104 and the printing device 110 as regards the capacity of the printing device for multi-processing may utilize any of several well known device management protocols. For example, Simple Network Management Protocol (SNMP) may be used for such exchanges as well as Microsoft's WSDPrint printer driver protocols. Still other printer management protocols are well known and may be employed for such printer management. Specifications for many of these well

Those of ordinary skill in the art will readily recognize that printing device 110 may include any number of processors including any number of general-purpose and/or special purpose processors each assigned to particular types of data objects. Still further, the multi-processing capability information may include any suitable form of information that defines a desirable re-ordering of data objects in the re-ordered print job. Data objects may be separated and re-ordered into any number of types of objects by print operation of job re-ordering element 108 and any number of such groups of types of objects may be provided in interleaved or alternating fashion with any number of other types of data objects.

Still further, those of ordinary skill in the art will readily recognize a variety of additional and equivalent elements in a fully operable system 100. Such additional or equivalent elements are omitted from FIG. 1 for simplicity and brevity of this discussion. Thus, FIG. 1 is intended merely as exemplary of one possible embodiment of a system incorporating features and aspects hereof.

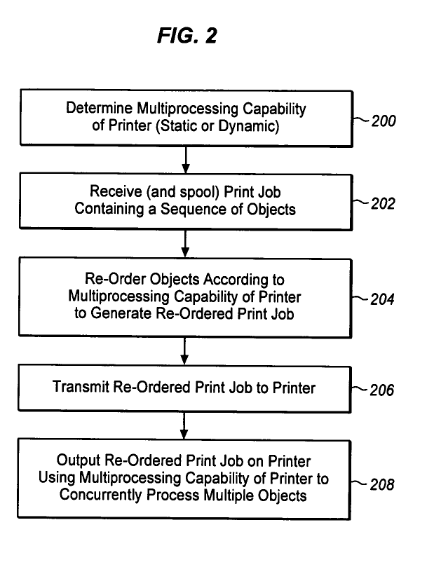

FIG. 2 is a flowchart describing an exemplary method in accordance with features and aspects hereof, operable in a host system, to re-order objects in a received print job in order to improve opportunities for parallel processing of data objects by multiple processors within an attached printing device. The method of FIG. 2 may be operable within a host system driver module of a system 100 such as in FIG. 1. Step 200 first determines the multi-processing capability of the attached printing device. As noted above, such a determination may be made with reference to static configuration information provided within the host system. Such static configuration information may be associated with a particular printing device model or may be associated with a specific physical printer attached to the host system. Further, as noted above, the enhanced driver module of the host system may dynamically determine the multi-processing capability of the printing device by receipt of such capability information from the printing device. This multi-processing capability information may be returned to the enhanced driver module asynchronously by operation of the printing device or in response to an inquiry from the enhanced diver module directed to the printing device. Further, as noted above, the capability information may include capacity of each processor to handle identified types of data objects in a re-ordered print job. For example, the capacity information may be expressed as a number (N) of image data objects that may be processed by one or more suitable special-purpose processors substantially in parallel with a second number (M) of other data objects to be processed by one or more other processors of the printing device. Those of ordinary skill in the art will readily recognize numerous other formats for expressing the capability of the printing device to process multiple types of objects in the print job in parallel using multiple processors in parallel.

Responsive to the determination of the capacity or capability of the printing device for multiple processing, step 202 then receives a print job from an appropriate source. The print job comprises a sequence of data objects. Since the driver module operating in a host computing environment may have significant resources at its disposal, the entire print job may be saved or spooled to improve the ability to re-order data objects in a re-ordered print job. The print job may be buffered or spooled in a suitable memory associated with the driver module on the host system including, for example, spooling to a persistent disk storage file. Step 204 then performs desired re-ordering of data objects according to the multi-processing capability of the printing device. Step 204 therefore generates a re-ordered print job having the original data objects re-ordered. As noted above, in accordance with one exemplary embodiment, the re-ordered data objects may be grouped such that a first number (N) of image data objects may precede (or follow) each group of (M) non-image or other data objects. Such grouping of objects may then continue alternating between image and non-image data objects in accord with the multiple processing capability and capacity of the printing device.

It will be readily apparent that any portion of the print job may be processed rather than awaiting receipt of the entire print job. In such a case, the processing of steps 202 and 204 may be repeated until all objects are processed such that as each portion of a print job is received the re-ordered data objects for that portion will be generated. Thus as used herein, “print job” may also be understood to mean any portion of the print job. For example, a portion may be a full document, multiple documents, portions of one or more documents, a

Step 206 then transmits the re-ordered print job to the printing device such that the multiple processors of the printing device may then operate substantially in parallel to process multiple objects from the re-ordered data. Step 208 then outputs the re-ordered print job on the printable medium by operation of the printing system. Based on the re-ordered data objects, the printer system processing of step 208 may better utilize its multi-processing capability to process multiple objects in parallel.

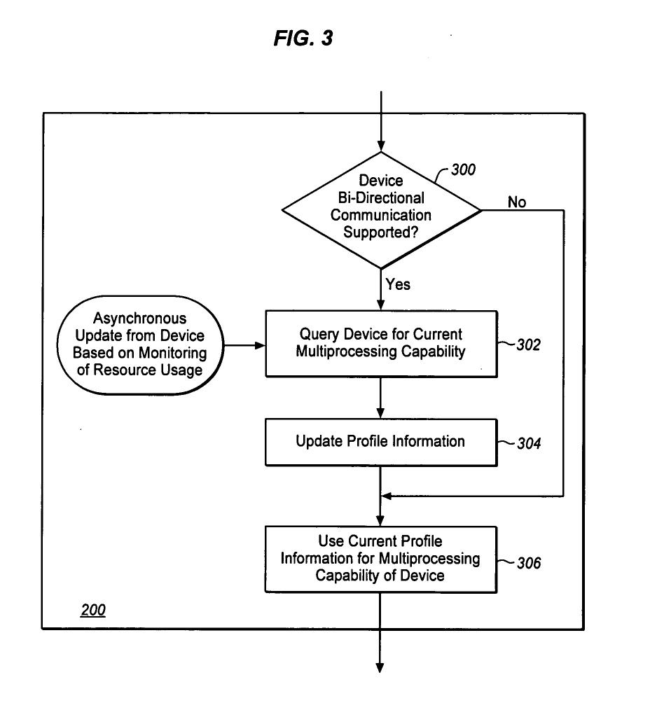

FIG. 3 is a flowchart providing exemplary additional details of the processing of step 200 of FIG. 2 to determine the present multi-processing capacity of the printing device. Step 300 determines whether the printing device is capable of bi-directional communication. If not, processing continues at step 306 to utilize current profile information for the printing device storing statically determined (e.g., preconfigured multi-processing capability of the printing device). If the printing device supports bi-directional communication for purposes of determining the present capacity for multiple processing, step 302 next queries the printing device to determine its current multi-processing capability or capacity. The printing device responds to such a query by returning current capacity of the multiple processors of the printing device for processing data objects substantially in parallel. Using such returned information, step 304 updates the current profile information for this printing device to represent its present capacity for parallel processing of multiple data objects. Step 306 then completes the processing as discussed above to utilize the current (now updated) capacity information for multiple processing of the printing device.

As noted above, other embodiments of features and aspects hereof allow for the printing device to asynchronously update the profile information by generating an appropriate message transferred to the enhanced driver module of the host system. Step 304 may therefore be asynchronously activated to update the current profile information regarding the printing device's capacity for multi-processing. In general, such an enhanced printing device may monitor resource usage within the printing device (e.g., within each processor of the printing controller). For example, resource usage such as CPU utilization for each processor, memory utilization for each processor, and other performance and communication bandwidth parameters for each processor may be continually monitored by features within the enhanced printing device. When a significant change of the multiple processing capacity of the enhanced printing device is so detected, an asynchronous message may be generated and forwarded to the enhanced driver module of the attached host system to permit the driver module to update its profile information regarding this printing device by operation of step 304. Those of ordinary skill in the art will readily recognize numerous particular resources that may be so monitored to determine when the performance capacity of the printing device has changed.

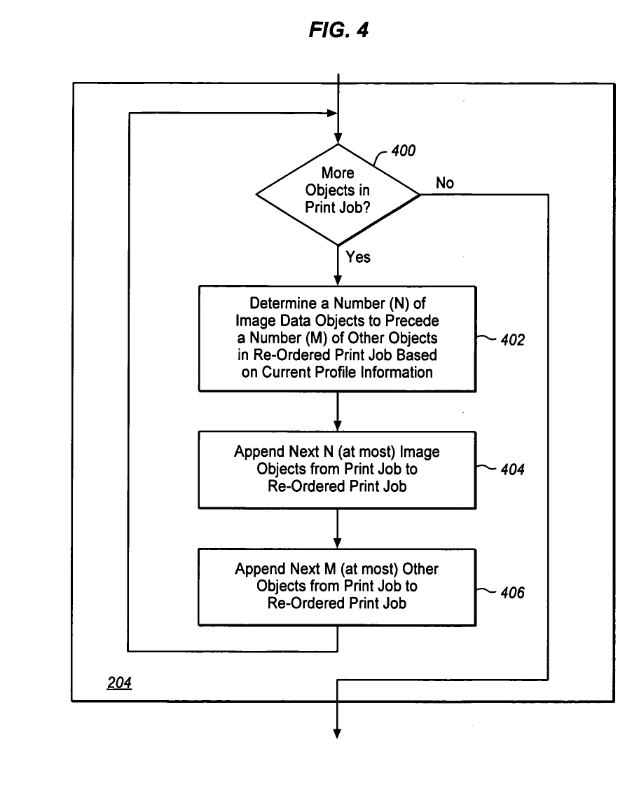

FIG. 4 is a flowchart providing exemplary additional details of the processing of step 204 of FIG. 2 to re-order the data objects of the print job thereby generating a re-ordered print job in accordance with the current multiple processing capacity of the printing device. The flowchart of FIG. 4 exemplifies processing for a driver to re-order a print job for a printing system with 2 processors—one specialized for image data object processing and a second for all other object processing. Those of ordinary skill in the art will readily recognize that the method may be extended to any number of processors each adapted for processing one or more types of data.

Step 400 first determines whether additional data objects remain in the original print job to be processed. If so, step 402 determines a number (N) of image data objects desirable to precede (or follow) a second number (M) of other, non-image data objects to be placed in the re-ordered print job based on current profile information for the printing device. Having so determined the first and second numbers (N and M), step 404 appends at most N of the next image data objects from the original print job into the re-ordered print job. Step 406 then appends at most M other, non-image data objects from the original print job to the re-ordered print job. Processing then continues looping back to step 400 until all data objects of the original print job have been appropriately appended to the re-ordered print job.

As noted above, numerous other forms of capacity or capability information regarding the multiple processing capabilities of the printing device may be utilized for purposes of re-ordering data objects from the original print job to generate the re-ordered print job. Thus the described re-ordering that alternates a number of image data objects followed by a second number of other non-image data objects is intended merely as one exemplary type of re-ordering in accordance with features and aspects hereof.

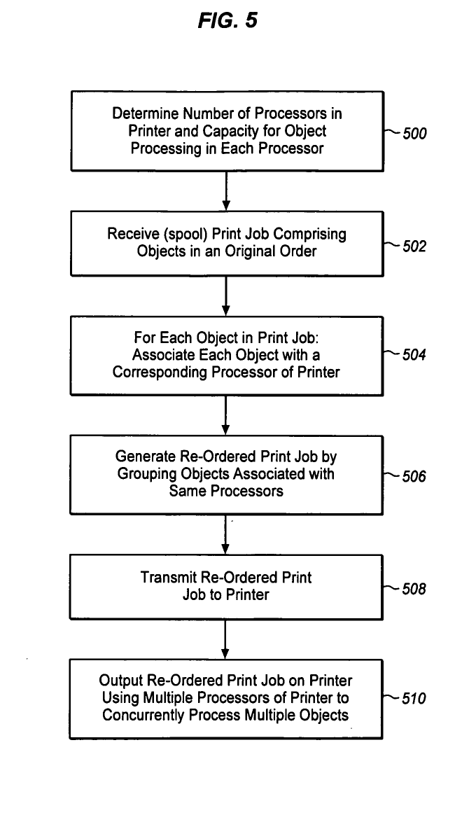

FIG. 5 is a flowchart describing another exemplary method in accordance with features and aspects hereof for operating an enhanced driver module to re-order data objects in a print job thereby permitting improved parallel processing of data objects within the printing device having multiple processors. Step 500 first determines the number of processors in the printing device and the capacity for object processing within each of the identified processors. As noted above, such capacity or capability information regarding each of the multiple processors in the printing device may be obtained from static configuration information regarding the particular printing device and/or may be determined from communication with the printing device to obtain current capability or capacity information therefrom.

Step 502 then receives (spools) an original print job comprising a plurality of objects sequenced in an original order. As noted above, since the enhanced driver module is operable on the host system, substantial resources (as compared to resources within the printing device) are generally available for the driver module to spool the entire print job (or any supplied portion thereof) to allow more thorough analysis and re-ordering of data objects in accordance with the capacity and capabilities for multiple processing on the attached printing device.

For each data object in the spooled print job, step 504 associates the object with a corresponding processor of the multiple processors in the printing device. In one exemplary embodiment, each data object may be associated with a particular type such as, for example, image data objects, text data objects, vector data objects, color data objects, graphical data objects, etc. Further, each processor of the multiple processors of the printing device may be identified as adapted for processing one or more of the various types of objects. Thus each object may be associated with a corresponding printer based on the type of data object.

Step 506 then generates a re-ordered print job by grouping data objects associated with the same processors. Continuing with the example above, all image data objects may be associated with a processor specifically adapted for image data processing. Vector data objects may be grouped together as being associated with a processor specifically adapted for vector data processing. Other data objects may be grouped according to their associated types and processors for processing of those types. Further, as discussed above, the capacity or capability information may also indicate specific numbers of each type of data

In a best case scenario, the re-ordered objects are grouped such that each of the multiple processors completes processing at approximately the same time and may then be restarted processing a next group of similarly typed objects. In particular, for example, a group of N image data objects may be processed in approximately the same elapsed time as a group of M other objects—each performed by operation of an associated processor (e.g., an image object processor and another object processor).

While the invention has been illustrated and described in the drawings and foregoing description, such illustration and description is to be considered as exemplary and not restrictive in character. Various embodiments of the invention and minor variants thereof have been shown and described. In particular, those of ordinary skill in the art will readily recognize that exemplary methods discussed above may be implemented as suitably programmed instructions executed by a general or special purpose programmable processor or may be implemented as equivalent custom logic circuits including combinatorial and/or sequential logic elements. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method for forwarding a print job to a printer, the method comprising:
determining multi-processing capability within the printer;
receiving a print job to be forwarded to the printer;
re-ordering objects in the print job to generate a re-ordered print job in accordance with the multi-processing capability of the printer; and
forwarding the re-ordered print job to the printer for output of the print job on the printer using the multi-processing capability of the printer to process multiple objects in parallel on the printer.

2. The method of claim 1
wherein the step of determining further comprises:
determining said multi-processing capability of the printer from static configuration information regarding the printer.

3. The method of claim 1
wherein the step of determining further comprises:
querying the printer to request information regarding multi-processing capability from the printer; and
receiving said information regarding multi-processing capability from the printer responsive to the query request.

4. The method of claim 1
wherein the multi-processing capability is determined from information that identifies capacity of a first processor of the printer adapted to process image data objects and from information that identifies capacity of a second processor of the printer adapted for processing other data objects.

5. The method of claim 4
wherein the information further identifies a first number of image data objects that may be processed in parallel with an identified second number of other data objects, and
wherein the step of re-ordering further comprises:
re-ordering the objects to alternate said first number of image data objects and said second number of other data objects in the re-ordered print job.

6. The method of claim 1
wherein the step of re-ordering further comprises:
spooling the objects of the print job to allow optimal re-ordering of the objects in the re-ordered print job.

7. The method of claim 1 further comprising:
dynamically updating multi-processing capability of the printer responsive to updated information received from the printer.

8. In a system including a host system coupled to a multifunction device, a method for re-ordering objects in a print job, the method comprising:
determining, within the host system, a capacity of a first processor of the multifunction device to process image objects and a capacity of a second processor of the multifunction device to process other data objects wherein the capacities are determined from profile information regarding the multifunction device;
identifying, within the host system, image data objects in a received print job that may be processed in parallel with other data objects in the received print job;
re-ordering, within the host system, objects in the print job to generate a re-ordered print job having image data objects grouped together and other data objects grouped together in accordance with the capacity of the first and second processors;
transmitting the re-ordered print job from the host system to the multifunction device; and
processing, within the multifunction device, image objects of the re-ordered print job using the first processor of the multifunction device while processing other objects in parallel using the second processor of the multifunction device wherein the processing outputs the re-ordered print job on the multifunction device.

9. The method of claim 8 further comprising:
monitoring, within the multifunction device, usage of resources of the multifunction device by each of the first and second processors; and
reporting from the multifunction device to the host system a change in the profile information based on a sensed change in the usage of the resources.

10. The method of claim 9
wherein the step of determining further comprises:
dynamically determining, within the host system, the capacity of the first processor and the capacity of the second processor based on current profile information just prior to the steps of identifying and re-ordering.

11. A method operable in a host system adapted for coupling to a printer having multi-processing capability, the method comprising:
determining a number of multiple processors in the printer;
receiving a print job to be sent to the printer, the print job comprising a sequence of objects;
identifying objects in the received print job and associating each identified object with a corresponding processor of the multiple processors of the printer;
re-ordering objects in the print job to generate a re-ordered print job having objects grouped together that are associated with a common corresponding processor; and
transmitting the re-ordered print job to the printer to generate printed output where objects are processed in parallel on the multiple processors of the printer.

12. The method of claim 11
wherein a first processor of the multiple processors is adapted to process image objects of the re-ordered print job, and
wherein a second processor of the multiple processors is adapted to process other objects of the re-ordered print job.

13. The method of claim 11
wherein the step of determining further comprises:
determining the number of multiple processors from static configuration information regarding the printer.

14. The method of claim 11
wherein the step of determining further comprises:
querying the print to dynamically determine the number of multiple processors from information received from the printer responsive to the querying.

15. The method of claim 14
wherein the step of determining further comprises:
receiving current capacity information regarding capacity of each processor to process objects of the re-ordered print job, and
wherein the step of re-ordering further comprises:
re-ordering the objects in accordance with the current capacity information.

16. The method of claim 15
wherein the step of receiving current capacity information further comprises:
receiving current capacity information that identifies a first number of image data objects that may be processed in parallel with an identified second number of other data objects, and
wherein the step of re-ordering further comprises:
re-ordering the objects to alternate said first number of image data objects and said second number of other data objects in the re-ordered print job.

17. A system for printing a document on a printing device having multiple processors, the apparatus comprising:
a host system; and
a driver module in the host system coupling the host system to the printing device and adapted to receive a print job from the host system, wherein the driver module includes:
a printer multi-processing capability analyzer module for determining multi-processing capability information regarding the printing device; and
a print job re-ordering module for re-ordering data objects in a received print job in accordance with the multi-processing capability information to generate a re-ordered print job,
wherein the driver module is adapted to transmit the re-ordered print job to the printing device for generating output using the multiple processors of the printing device.

18. The system of claim 17
wherein the analyzer module is adapted to determine the multi-processing capability information from static configuration information regarding the printing device.

19. The system of claim 17
wherein the analyzer module is adapted to determine the multi-processing capability information from dynamic capacity information received from the printing device.

20. The system of claim 17
wherein the multi-processing capability information comprises:
capacity information regarding the capacity of each of the multiple processors for processing associated types of data objects.

21. The system of claim 17
wherein the multi-processing capability information comprises:
a first number (N) of image data objects that may be processed by a first processor of the multiple processors; and
a second number (M) of non-image other data objects that may be processed by a second processor of the multiple processors in parallel with the N image objects processed by the first processor.

22. The system of claim 17
wherein the re-ordering module is adapted to group data objects together that may be processed by a first processor of the multiple processors and adapted to group other data objects together that may be processed by a second processor of the multiple processors in parallel with the first processor.

23. The system of claim 17
wherein the multi-processing capability information comprises:
a first number (N) of image data objects that may be processed by a first processor of the multiple processors; and
a second number (M) of non-image other data objects that may be processed by a second processor of the multiple processors in parallel with the N image objects processed by the first processor, and
wherein the re-ordering module is adapted to group N image data objects together that may be processed by the first processor and adapted to group other M non-image other data objects together that may be processed by the second processor in parallel with the first processor.
